(19) United States
(12) Patent Application Publication
(10) Pub. No.: US 2008/0130706 A1
(43) Pub. Date: Jun. 5, 2008

(54) PROCESS AND DEVICE FOR DETERMINING THE HYGIENIC STATE OF AN ACCESSORY FOR A MEDICAL BASIC DEVICE

(75) Inventors: Bernd KELLNER, Lubeck (DE); Henning GERDER, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: DRAGER MEDICAL AG & CO. KG, Lubeck (DE)

(21) Appl. No.: 11/924,762

(22) Filed: Oct. 26, 2007

(30) Foreign Application Priority Data
Dec. 5, 2006 (DE) 10 2006 057 196.7

(51) Int. Cl. G01N 25/00; G01K 13/00

(52) U.S. Cl. 374/45; 374/141

(57) ABSTRACT

The present invention pertains to a device and a process for determining the hygienic state of an accessory (1) for a medical basic device (3), in which temperature events of the accessory (1) corresponding to the exceeding of a preset temperature are stored with the corresponding times, the stored temperature events with the corresponding times are compared with comparison values for temperature and time, so that a display, output and/or alarm is brought about at the medical basic device (3) in case the temperature exceeds the comparison value for a preset total time or for a preset number of temperature events.

### CROSS REFERENCE TO RELATED APPLICATIONS

This application claims the benefit of priority under 35 U.S.C. §119 of German Patent Application DE 10 2006 057 196.7 filed Dec. 5, 2006, the entire contents of which are incorporated herein by reference.

### FIELD OF THE INVENTION

The present invention pertains to a process and a device for determining the hygienic state of an accessory for a medical basic device.

### BACKGROUND OF THE INVENTION

A medical basic device is, for example, an anesthesia device or a respirator.

An accessory for such a medical basic device is, for example, a breath flow sensor or another component or functional element that comes into contact with breathing gas of a patient. To meet the hygienic requirements imposed on such accessories for the health of the patient being respirated, these accessories are subjected to autoclave treatment or cleaning cycles in case of multiple use. It must be ensured by corresponding logistics that such accessories, which are to be cleaned, will only be put into use again at or for the patient in a sterile state.

The number of cleaning or processing cycles are limited by the design or the material in case of some accessories.

The operating staff in charge has hitherto had to sort out the consumed accessories, mostly by visual inspection or function tests. As an alternative, corresponding lists with accessories, part names, part numbers are maintained, by means of which the number of cleaning cycles performed, such as washing or autoclave treatment, are monitored.

### SUMMARY OF THE INVENTION

The object of the present invention is to provide a process and a device, which offers the user a reliable and convenient possibility of determining the current hygienic state of an accessory for a medical basic device in order to sort out accessories that may have been consumed.

According to the invention, the hygienic state of an accessory for a medical basic device is determined. A medical basic device is provided. An accessory for the medical basic device is initiated and an initiation time is started. A temperature of the accessory is regularly measured to provide a plurality of temperature values. Each measured temperature value has an associated measuring time. Each measured temperature with a respective measuring time is stored. A measured temperature defines a temperature event of the accessory when a value of the measured temperature exceeds a preset temperature value at an associated measuring time. One stored temperature value measured at one measuring time is compared with another stored temperature measured at another measuring time with the medical basic device to determine a number of temperature events and an amount of elapsed time between each temperature event with respect to the initiation time. A warning signal is generated as an output based on the number of temperature events and the amount of elapsed time between the temperature events with respect to the initiation time. The medical device displays a hygienic state of the accessory based on the warning signal.

The accessory has a memory unit. The accessory may be located in a cleaning device. The accessory can be in wireless communication with a writing unit. Each temperature event of the accessory is stored in the memory unit of the accessory during an autoclave treatment via the writing unit.

The amount of time during which a measured temperature is exceeded during a temperature event is stored in the memory of the accessory.

A temperature exceeding 70° C. to 80° C. for at least 60 sec is stored as a temperature event in the memory.

The initiation time for each temperature event of the accessory is stored in the memory unit. The memory unit stores the amount of time of each temperature event.

The warning signal is generated as output when the number of measured temperature events exceeds a predetermined temperature event limit or when the amount of elapsed time of the measured temperature event exceeds a preset time period.

In another embodiment, the present invention provides a device for determining the hygienic state of an accessory for a medical basic device. The device comprises a medical basic device. An accessory element is in communication with the medical basic device. The accessory element has a memory for storing temperature values and corresponding measurement or initiation time or time interval of the temperature values. The device also comprises a communication module. The medical basic device is connected to the memory via the communication module. The communication module receives the stored temperature values with the corresponding measurement or initiation time or time interval. The medical basic device analyzes the temperature values and the corresponding measurement or initiation time or time interval to determine an amount of temperature events and a duration of time for each temperature event. The medical basic device has an output, display and/or an alarm for alerting a user of a hygienic state of the accessory.

The accessory has a temperature sensor.

The medical basic device can be an anesthesia device or a respirator.

The accessory can be a breath flow or flow sensor or a tube system or an expiration valve.

The accessory has a communication unit. The temperature sensor, the memory unit and the communication unit of the accessory are designed as one assembly unit with a transponder.

In another embodiment, the present invention provides a process for determining the hygienic state of an accessory for a medical basic device. A medical basic device is provided. An accessory for interacting with the medical basic device is initiated. The accessory has a temperature sensor. The temperature of the accessory is measured to provide a plurality of measured temperature values. Each measured temperature value has a corresponding temperature time. The plurality of measured temperature values with the corresponding temperature times are stored. The plurality of measured temperature values and the corresponding temperature times are analyzed to determine a number of cleaning treatments of the accessory and the amount of elapsed time between each cleaning treatment. A cleaning treatment of the accessory is defined when one of the measured temperature values exceeds a temperature threshold value of the accessory at one of the corresponding time values. The number of uses of the accessory and the elapsed time between each cleaning treatment are provided.

A warning signal is generated as an output when a number of measured cleaning treatments based on the temperature comparison exceeds a predetermined cleaning treatment limit or when an amount of time of between the cleaning treatments based on the temperature comparison exceeds a preset cleaning treatment time period. The medical device displays a hygienic state of the accessory based on the warning signal.

Each cleaning treatment of the accessory is stored based on the temperature comparison in the memory unit of the accessory during an autoclave treatment via a writing unit.

The amount of time during which a measured temperature is exceeded during a cleaning treatment is stored in the memory of the accessory.

A temperature exceeding 70° C. to 80° C. for at least 60 sec is stored as a cleaning treatment in the memory.

A corresponding starting time for each cleaning treatment of the accessory is stored in the memory unit. The memory unit stores the amount of time of each cleaning treatment based on the comparison of the temperatures.

The temperature threshold value of the accessory is in a range from 70° C. to 80° C.

The accessory includes an operating system. The operating system collects the first measured temperature and the second measured temperature. The operating system sends the first measured temperature and the second measured temperature to the memory unit.

The medical basic device has an alarm means for alerting a user of the hygienic state of the accessory based on the warning signal. The medical device has a communication module. The communication module is in communication with the memory unit such that the medical device receives the stored measured temperatures from the memory unit via the communication module.

By incorporating a temperature sensor in the accessory, for example, into a breathing tube, a breath flow sensor or an expiration valve with an associated memory, it can be determined by means of a temperature measurement and data recording with analysis whether and when and optionally for how long the accessory was subjected to a thermal cleaning or treatment process. Consequently, relevant temperature events are detected and analyzed by comparison.

A start-up procedure preferably combined herewith ascertains during the rigging up of the device that the temperature sensor is checked, the memory is read and accessories not permissible for the basic device are recognized.

The temperature sensor is preferably incorporated permanently in the accessory. A suitable form of incorporation is in the form of a transponder unit with a temperature sensor, for example, one based on a semiconductor element, with an integrated circuit with memory and energy storage means.

The integrated circuit determines, for example, at settable time intervals, the current temperature at the accessory and stores this with a date stamp in the memory.

The memory is read as soon as the transponder unit is introduced into an HF field of the writing and reading unit of the medical basic device, so that the memory can be read, erased and rewritten.

The analysis is performed especially such that the temperature values or the temperature excesses that were measured since the last reading or since putting into operation in case of new accessories are read. The analysis of the temperature values provides information on whether and how many cleaning or autoclave treatment cycles have taken place, and on the points in time at which the accessory was subjected to a corresponding treatment and for how long.

Due to the fact that the autoclave treatment temperature, with about 134° C., is far above the usual working temperature of the accessories, it is sufficient to determine when and for how long a housing temperature of the accessory of, e.g., 70° C. to 80° C. was exceeded.

How long ago the last autoclave treatment procedure had been performed can thus be recognized. Together with a time stamp, which was written into the memory of the accessory at the time of the most recent connection of the accessory to the memory, it can be analyzed whether the autoclave treatment has meanwhile taken place. For example, the counter is subsequently updated for the autoclave treatment cycles performed, and the measured temperature values with the corresponding characteristic times are optionally stored for documentation. A type stamp is especially preferably entered additionally in the memory of the accessory, so that an upper limit of autoclave treatment cycles can be included in the analysis, prognoses can be made for the further future use of the accessory, and additional information on the accessory at the medical basic device may optionally be outputted, such as:
Date of manufacture
Data on the first connection of the accessory to the basic device with read/write functionality
Time of most recent autoclave treatment
Most recent connection to a medical basic device equipped with reader
Number of autoclave treatment cycles since first connection
Remaining number of permissible autoclave treatment cycles
Prognosis for the remaining service life of the accessory based on the past pattern of use.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing an arrangement of an anesthesia device as a medical basic device with a cable-bound breath flow sensor/flow sensor arranged near the patient as an accessory;

FIG. 2 is a schematic view showing a medical basic device with a breath flow sensor/flow sensor as an accessory and without active electronic components;

FIG. 3 is a schematic view corresponding to FIG. 2, but with reusable passive accessories such as breathing tubes or tube systems; and

FIG. 4 is a schematic view showing an example of using a system and device of the invention with a cleaning device for accessories, without continuous temperature measurement, wherein the accessories are written to by the cleaning device or by an associated writing unit.

### DESCRIPTION OF THE PREFERRED EMBODIMENTS

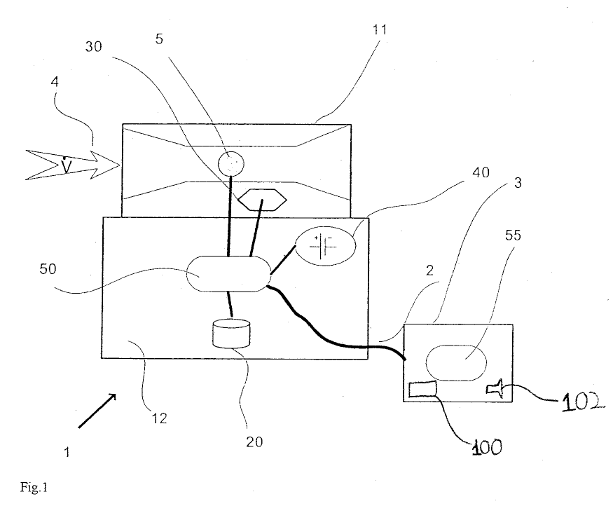

Referring to the drawings in particular FIG. 1, the accessory 1 comprises the breath flow sensor cell 11 proper and a measuring electronic unit 12 and has a flow measuring element 5, for example, a hot wire device for measuring the passage of the breath flow 4.

In addition, a temperature sensor 30, a data logging system 50 for logging the measured value of the temperature sensor 30 and a memory 20 are integrated in the accessory 1.

A battery 40 designed as a primary battery or as a storage battery ensures the energy supply for the operating system 50 for the period without cable connection 2 to the medical basic device 3 designed as an anesthesia device here. The operating system 50 collects the measured temperature values of the temperature sensor 30 at preset time intervals and stores them in the memory 20.

The operating system 50 can also perform an analysis of the data, for example, in order to exclude from storage measured values not relevant for data storage or to specially mark such measured values during storage. When the medical basic device 3 is equipped with the accessory 1, the energy supply and the operation of the flow sensor are ensured via the cable connection 2. In addition, bidirectional data communication is established between the sensor electronic unit and the communication module 55 of the basic device 3. The stored data are transferred from the memory 20 into the medical basic device 3 and used there for displaying via a display 100 or analyzing the hygienic state of the accessory 1. An alarm 102 also is provided for alerting a user of the medical basic device 3 of the hygienic state of the accessory 1.

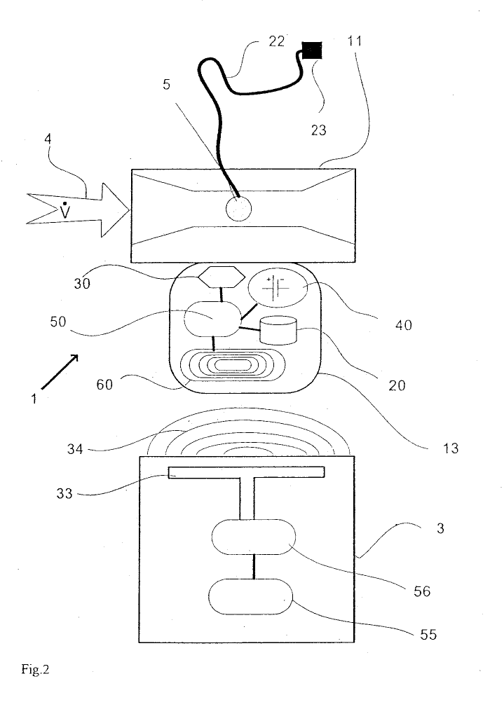

FIG. 2 shows an embodiment for a breath flow/flow sensor without active electronic components for the operation of the sensor system, where identical functional elements are designated by the same reference numbers as in FIG. 1. The stored measured temperature data are read by means of the radio frequency identification technique (RFID). A transponder “tag” 13 is arranged for this at the breath flow sensor cell 11. This transponder 13 contains the memory 20, the operating system 50, an antenna 60, the battery 40 and the temperature sensor 30. A write/read unit 56 and a write/read antenna 33 are additionally contained in the basic device 3. The temperature detection and data storage functions are performed similarly to what is described in connection with FIG. 1.

The data from the memory 20 are read via the electromagnetic field 34 of the write/read unit 56 with the writing/read antenna 33 of the basic device 3.

The breath flow sensor is not necessarily connected to the anesthesia device via the cable connection 22 and the plug-type connector 23 in this variant.

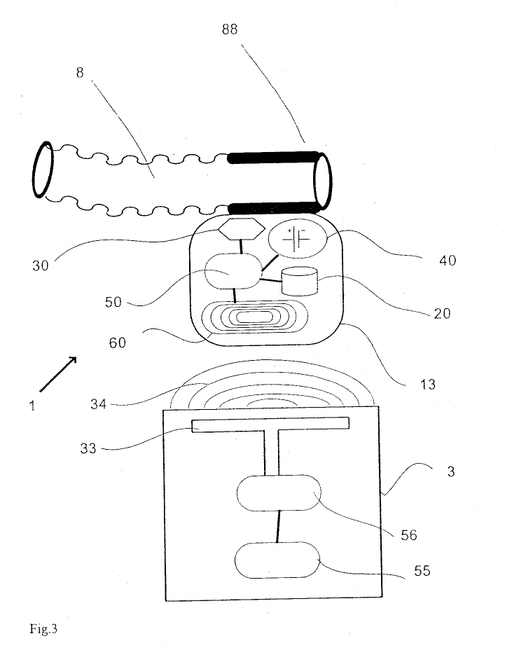

FIG. 3 shows an example of using a system and device corresponding to FIG. 2 for reusable passive accessories that do not send measured signals, for example, tube systems 8.

The transponder 13, shown schematically as an oversized transponder, is arranged at a connection branching 88, for example, it is actually attached as a flat film in the form of a sticker or injected into the tube.

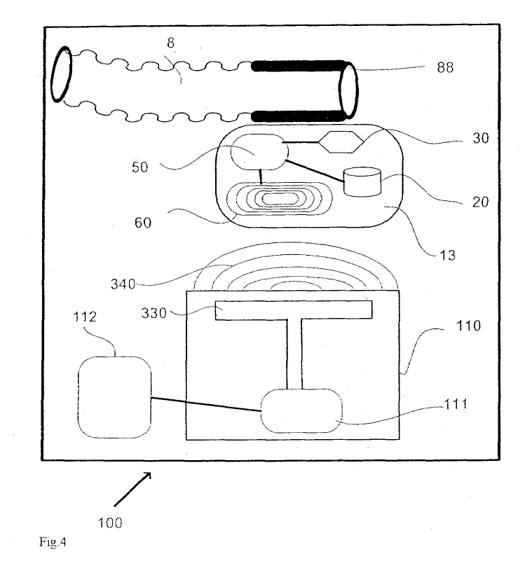

FIG. 4 shows an example of using a system and device of the invention for the case in which no continuous temperature measurement is necessary in the accessory 3. The tube system 8 is cleaned or autoclaved in the cleaning device 100. The peculiarity of this embodiment is that process data or temperature values are written here to the memory 20 in the transponder 13 of the tube system 8 in a cleaning device 100 designed as an autoclave treatment or washing device at the end of the cleaning procedure.

The cleaning device 100 ensures the correct course of the cleaning procedure by corresponding cleaning programs.

An analysis module 112 for monitoring the cleaning operation, a communication unit 111 as well as a write/read unit 110 for the transponder 13 of the tube system 8 are integrated in the cleaning device 100.

The writing unit 110 supplies the transponder 13 with energy during the writing to the memory 20 and with data on the point in time and the duration of cleaning via the antenna 330 and the electromagnetic field 340. Old data are optionally deleted.

A temperature sensor 30 is integrated if separate monitoring of the part temperature is optionally necessary.

The use according to this embodiment does not require any battery 40 and continuous temperature data logging.

The data read into the memory remain in the memory 20 until they can be read by the medical basic device 3 via the communication module 55 (FIGS. 1 through 3).

The memory 20 can be read in a wired form according to FIG. 1, but field-based reading of the process data is also possible corresponding to FIG. 2 or 3.

The use of the device and system according to FIG. 4 with a cleaning device 100 with the tube system 8 to be cleaned therein as an accessory offers the additional possibility that the cleaning device 100 adapts itself to the parts to be cleaned. Thus, it would be possible to store in the memory 20 of the accessories a data set with the part-specific autoclave treatment cycle to be employed, which the cleaning device 100 will then read and the cleaning device will control its cleaning processes correspondingly.

While specific embodiments of the invention have been shown and described in detail to illustrate the application of the principles of the invention, it will be understood that the invention may be embodied otherwise without departing from such principles.

What is claimed is:

1. A process for determining the hygienic state of an accessory for a medical basic device, the process comprising the steps of:
providing a medical basic device;
initiating an accessory for said medical basic device and starting an initiation time;
regularly measuring a temperature of said accessory to provide a plurality of temperature values, each measured temperature value having an associated measuring time;
storing each measured temperature with said associated measuring time, wherein one said measured temperature defines a temperature event of said accessory when a value of said measured temperature exceeds a preset temperature value at one said associated measuring time;
comparing one stored temperature value measured at one measuring time with another stored temperature measured at another measuring time with said medical basic device to determine a number of temperature events and an amount of elapsed time between each said temperature event with respect to said initiation time;
generating a warning signal as an output based on said number of temperature events and said amount of elapsed time between said temperature events with respect to said initiation time, said medical device displaying a hygienic state of said accessory based on said warning signal.

2. The process in accordance with claim 1, wherein said accessory has a memory unit, said accessory being located in a cleaning device, said accessory being in wireless communication with a writing unit, each temperature event of said accessory being stored in said memory unit of said accessory during an autoclave treatment via said writing unit.

3. The process in accordance with claim 2, wherein the amount of time during which a measured temperature is exceeded during a temperature event is stored in said memory of said accessory.

4. The process in accordance with claim 2, wherein a temperature exceeding 70° C. to 80° C. for at least 60 sec is stored as a temperature event in said memory.

5. The process in accordance with claim 2, wherein said initiation time for each temperature event of said accessory is stored in said memory unit, said memory unit storing the amount of time of each said temperature event.

6. The process in accordance with claim 1, wherein said warning signal is generated as said output when said number of measured temperature events exceeds a predetermined temperature event limit or when said amount of elapsed time of said measured temperature event exceeds a preset time period.

7. A device for determining the hygienic state of an accessory for a medical basic device, the device comprising:
a medical basic device;
an accessory element in communication with said medical basic device, said accessory element having a memory for storing temperature values and corresponding measurement or initiation time or time interval of said temperature values;
a communication module, said medical basic device being connected to said memory via said communication module, said communication module receiving said stored temperature values with said corresponding measurement or initiation time or time interval, said medical basic device analyzing said temperature values and said corresponding measurement or initiation time or time interval to determine an amount of temperature events and a duration of time for each temperature event, said medical basic device having an output, display and/or an alarm for alerting a user of a hygienic state of said accessory.

8. A device in accordance with claim 7, wherein said accessory has a temperature sensor.

9. A device in accordance with claim 7, wherein said medical basic device is an anesthesia device or a respirator.

10. A device in accordance with claim 7, wherein said accessory is a breath flow or flow sensor or a tube system or an expiration valve.

11. A device in accordance with claim 10, wherein said accessory has a communication unit, said temperature sensor, said memory unit and said communication unit of said accessory being designed as one assembly unit with a transponder.

12. A process for determining the hygienic state of an accessory for a medical basic device, the process comprising the steps of:
providing a medical basic device;
initiating an accessory for interacting with said medical basic device, said accessory having a temperature sensor;
measuring a temperature of said accessory with said temperature sensor to provide a plurality of measured temperature values, each measured temperature value having a corresponding temperature time value;
storing said measured temperature values and said corresponding temperature time values;
analyzing said plurality of stored temperature values and said stored corresponding temperature time values to determine a number of cleaning treatments applied to said accessory and an amount of elapsed time between each cleaning treatment, wherein a cleaning treatment of said accessory is defined when one of said stored measured temperature values exceeds a temperature threshold value of said accessory at one corresponding said temperature time value;
providing the number of cleaning treatments of said accessory and said elapsed time between each said cleaning treatment.

13. The process in accordance with claim 12, further comprising the step of generating a warning signal as an output when a number of measured cleaning treatments exceeds a predetermined cleaning treatment limit or when an amount of time of between said cleaning treatments exceeds a preset cleaning treatment time period, said medical device displaying a hygienic state of said accessory based on said warning signal.

14. The process in accordance with claim 12, wherein said accessory has a memory unit, said accessory being located in a cleaning device, said accessory being in wireless communication with a writing unit, each cleaning treatment of said accessory being stored in said memory unit of said accessory during an autoclave treatment via said writing unit.

15. The process in accordance with claim 14, wherein the amount of time during which a measured temperature is exceeded during a cleaning treatment is stored in said memory of said accessory.

16. The process in accordance with claim 14, wherein a temperature exceeding 70° C. to 80° C. for at least 60 sec is stored as a cleaning treatment in said memory.

17. The process in accordance with claim 14, wherein a corresponding starting time for each cleaning treatment of said accessory is stored in said memory unit, said memory unit storing the amount of time of each said cleaning treatment.

18. The process in accordance with claim 12, wherein said housing temperature of said accessory is in a range from 70° C. to 80° C.

19. A process in accordance with claim 14, wherein said accessory includes an operating system, said operating system collecting said plurality of measured temperature values, said operating system sending each measured temperature value to said memory unit.

20. A process in accordance with claim 12, wherein said accessory has a communication unit, said temperature sensor, said memory unit and said communication unit of said accessory being designed as one assembly unit with a transponder, said medical basic device having an alarm means for alerting a user of said hygienic state of said accessory based on said warning signal, said medical device having a communication module, said communication module being in communication with said memory unit such that said medical device receives said stored measured temperature values from said memory unit via said communication module.
